(19) United States
(12) Patent Application Publication
(10) Pub. No.: US 2012/0150762 A1
(43) Pub. Date: Jun. 14, 2012

(54) Method of Screening People

(75) Inventor: Thomas Caton Ormerod, Cumbria (GB)

(73) Assignee: Lancaster University Business Enterprises Limited, Lancaster (GB)

(21) Appl. No.: 13/158,925

(22) Filed: Jun. 13, 2011

(30) Foreign Application Priority Data
Jun. 14, 2010 (GB) 1009936.4

(51) Int. Cl. G06Q 99/00

(52) U.S. Cl. 705/325

(57) ABSTRACT

A process for managing a screening interaction with a passenger, comprises a procedure for establishing an account from a passenger, and questions to establish the veracity of that account, such that more effective information can be gathered about the user's true intentions and identity. A computer apparatus intended to enable this process to be implemented is also described.

### CROSS REFERENCE TO RELATED APPLICATION

The present application claims priority to United Kingdom Application No. 1009936.4 filed Jun. 14, 2010. The entirety of the aforementioned application is incorporated herein by reference for all purposes.

### FIELD

Embodiments described herein relate to screening of an individual or groups of individuals, particularly (but not exclusively) for use in security and identification procedures.

### BACKGROUND

It is known and desirable to screen people in a number of commercial and non-commercial (e.g., infrastructure protection) environments. One of the most visible examples of this is the pre-flight screening of airline passengers. This is an area of some controversy, as some view screening as insufficiently effective as to provide any benefit to the population as a whole. Moreover, current methods have an element of selective profiling, which is both inadequate in targeting unknown risks but can also be divisive and prejudicial. This leads to the need to carry out other, more intrusive techniques such as body scanning and the like, which are unpopular and possibly controversial.

It should be mentioned at the outset that the present embodiment is described in the context of possible implementation in aviation security. That is not to say that embodiments cannot be implemented in other contexts. Indeed, the reader will appreciate that the principles apply equally to other forms of transport, and to many other situations where it is desired to control access to a secure area and/or facility or other resources (e.g., benefits claimants).

It is known to require intending airline passengers to provide personal details ahead of travel so that risk-assessment algorithms can be run offline, with the results available at check-in time. Such personal information can include the name and address of the passenger, and/or other identifying information such as a passport or identity card (e.g. driver's license) number and travel itinerary.

Such risk assessment algorithms may make use of lists of names, and/or score a number of factors such as the detail of travel plans, place of birth, or place of residence, to generate a risk score.

Security checks can be made on the basis of, and at the point of, provision of information by a passenger. There are key events at which this occurs. For instance, at the point of purchase of an airline ticket, a passenger will be asked for name, address and payment details. If this process is carried out online, payment details will probably consist of credit card details or the like. If a ticket is purchased over the counter, cash may have been used—a potentially noteworthy piece of information itself, for security screening purposes.

Then, prior to take off, a passenger will need to undergo a check-in process. This can be completed, at least in part, on-line and remotely. Some airlines pose security based questions during an on-line check in procedure, but others do not do so at this stage in the process. Check-in may also be undertaken on arrival at an airport.

The principal purpose of check-in, from a passenger's perspective, is to present oneself to the airline to confirm an intention to travel. Seat selection can take place at the same time.

From the airline's perspective, both of these aspects of check-in are evidently important, but clearing passengers for travel, from a security perspective, is also vital. Air travel regulators impose requirements on airlines as to certain questions that must be asked of all passengers. This may include questions such as “Did you pack your bags yourself?” or the like. Such questions might vary from country to country, or from one regulated environment to another.

Clearly, such questions, in themselves, will not be a significant obstacle to anyone but the most naïve individual. Providing the answer that the airline wants to hear is known to be a prerequisite for travel. However, in this situation the questioner is really looking for so called “suspicious signs” from the intended passenger, which might include the appearance or behaviour thereof. The questioner needs to have significant insight into human behaviour to read signs of stress, nervousness or any other emotional state which could give rise to a determination of a higher risk profile than desirable. However, it is also worth noting that this insight is at least flawed since it is not possible to impute an intention behind a passively observed dispositional state.

International patent application WO03069447 provides an arrangement attempting to provide computer implemented security for the airline industry. The disclosure of that document takes account of the fact that, at passenger check-in, it is known to attempt to make a positive identification of a potential passenger using photographic identification documents such as a driving license and/or passport. It is also known to make an attempt at a positive identification of a potential passenger using biometric measurements such as fingerprints, iris scan, and/or retinal scan.

The disclosure continues by noting that it is known to question passengers immediately before and during check-in. Currently the questions are mainly aimed at checking identity, and (in response to certain past incidents) at the prevention of a passenger carrying bags and/or packages within bags for a third party. A relatively scripted, and quite artificial question and response session thus ensues. However, according to WO03069447, it is suggested that, with vigilance, a questioner can detect behaviour which leads to increased suspicion of a passenger's intentions, and such passengers can then be selected for more detailed security checks. Such security checks might result in denial to travel.

For use after check-in it is known to issue passengers with a token such as a boarding card, smart card, or electronic device so that their location and progress to the transportation vehicle may be monitored. It is known for passengers to be screened for undesirable items by a wide range of security machines. Equally passengers' hold luggage is similarly screened.

The disclosure of the WO03069447 patent application focuses on the provision of a risk assessment engine, in an attempt to quantify the potential risk of a passenger given all of these possible sources of information about the passenger's behaviour.

When applied to airport security, clearly the intention is to reduce (even to zero) the possibility of an intending terrorist to travel on a commercial aeroplane flight. It is established that such a person is likely to have used others to undertake reconnaissance before attempting to gain access to an aircraft. The person is likely to be well informed as to the security checks in place, and to have taken measures to avoid detection of physical items. False identity may be established by sophisticated forgeries that are hard to detect.

However, while physical characteristics and identity information can be disguised or forged, it is difficult for an intending malefactor to disguise his mental state. Existing standard security measures do not explore this, although those in place by the El Al airline of Israel are close to establishing this. Reference is made to an article by Oliver Burkeman in The Guardian, dated 1 Dec. 2007, for a brief description of the measures taken by El Al.

While most airline passengers' exposure to screening comprises simple responses to three closed questions (i.e. prompting a “yes” or “no” answer), there are additional requirements for travel by transatlantic passengers carried by US carriers into the US. In such circumstances, there is a mandatory requirement that passengers are screened against a TSA (US Transport Security Administration) checklist of suspicious signs. Such checking is often carried out immediately prior to check-in. If any pre-flight questioning detects a suspicious sign and fails to resolve it, then a passenger is made a “selectee” and is subjected to more rigorous physical search and documentation checks.

The design of the checklist and screening process reflects assumptions based on past experience, and so is inevitably not as responsive as it could be to current or future threats. Four factors have emerged that limit the effective use of behavioural cues in screening:
Many of the TSA suspicious signs are redundant or uninformative—particularly those pertaining to documentation or related to countries of suspicion. Others relating to journey and behaviour/appearance were similarly unpredictive. Time spent resolving these signs distracts from processing behavioural cues.
Questioning is driven primarily by seeking or resolving documentation and journey signs. This constrains the screening process, making questioning predictable and reducing the opportunity to observe behavioural cues (especially changes under questioning).
The most effective forms of questioning involve the use of open and/or informed questions, but this requires a high degree of skill, experience and knowledge among agents.
Agents worked hard to resolve suspicions, and to avoid creating selectees, but extensive questioning was not always cost-effective, secure or helpful to legitimate customers.

### BRIEF SUMMARY

An embodiment described herein provides a process for managing a screening interaction with a passenger, such that more effective information can be gathered about the user's true intentions and identity in order that a judgement of veracity can be made.

An embodiment described herein comprises a method of screening a person, comprising establishing a baseline demeanour of the person, gathering personal information about the person, seeking further information from the person relating to that person's background, asking one or more questions intended to determine if said further information is consistent and reliable and, on the basis of answers to said questions and the demeanour of the person, determining a level of confidence in said person.

The level of confidence can be translated into a screening result. The screening result could be binary (i.e. “pass” or “fail”) or may involve one or more intermediate gradings.

The baseline demeanour may be established by the asking of one or more questions which may be relatively straightforward to answer, such as concerning the personal experience of the person in reaching the point of screening. For example, if the screening is done in an airport environment, the baseline demeanour may be established by asking the person about his journey to the airport, or his destination. The questioner need not know the answer to the question put, and the answer given need not be recorded, as the intent is to check the demeanour of the person at this stage.

Personal information may be gathered contemporaneously via a tactical approach to interviewing, and may be complemented by a process of retrieving information, from a database, of pre-stored information about the person being screened.

The question or questions intended to determine if the further information is consistent and reliable may be derived from verification information known by or accessible to the questioner, and connected to the further information.

The question or questions may be such as to determine if the person, given knowledge of the further information, also knows the verification information. The verification information may comprise factual information which, on the basis of the further information provided by the person, it would be expected that the person would also know. The expectation of the person knowing the verification information, given knowledge of the further information, may be associated with the confidence determined for that person, if that person does not, in fact, know the verification information.

The specific embodiment described herein comprises a process which is dependent on, but not solely comprising, human to human interaction. The key to the process is in providing a framework around which the screener's decision-making about the interviewee's veracity is supported. In addition, the process relies on the ability of a questioner, a screening operative, to determine from changes in body language and other non-verbal communication during the screening process, the demeanour of a screened party. In the present embodiment, the screening operative is a member of staff of an airline, who is trained to make determinations as to the fitness of a potential passenger to travel. Such a person may be dedicated to that task, or may be primarily involved in an associated activity, such as passenger check-in. This screening process may appropriately be carried out at passenger check-in.

The specific embodiment provides a short interview procedure comprising three distinct phases. Although a three phase approach characterises the embodiment, the procedure is presented to the passenger as a homogenous interview so as to avoid arousing suspicion therein.

Each of the three phases of the procedure is intent on gathering information from the prospective passenger. Each phase contributes individually and incrementally to determining whether a passenger is a bona fide traveller without malicious intent or dubious identity. At the same time, the procedure is designed to be efficient, establishing confidence to fly in three minutes.

An information-gathering approach to interview-based screening has the potential to assist screeners to detect deception. This is achieved, in accordance with the present specific embodiment, by defining a number of design layers that maximize deception detection in an airport setting:
1. Design of the types of questions asked and the order of presentation;
2. Design to ensure acquisition of baseline judgement of verbal/dispositional behaviour early in the procedure;
3. Design to ensure an element of uncertainty by asking questions that are less easy for the passenger to anticipate and/or predict (moving away from predetermined scripted questions concerning passenger identity and journey details).
4. Design so that screeners control the face-to-face cognitive encounter, utilising technology to support rather than determine the outcome of screening (avoiding an over-automated or inflexible procedure).

The procedure provides a controlled interviewing procedure with clear exit points. It can be characterised by an incremental questioning approach, with initial questions designed to put the subject at ease and to determine a baseline of the demeanour of the subject, and then further phases of questions designed to establish what version of the truth the subject is intent on presenting, and then methods for testing the version presented by the subject. Through this, by using trained cognitive skills of the screener in a structured way, the screener is able to determine whether the answers given by a passenger are consistent with that passenger being a bona fide traveller, or whether they raise suspicions of deceptive intent.

At the same time, the form of interviewing (i.e. the structure of the interview process) is designed such that, while a genuine traveller will have no difficulty in addressing the questions raised by the screener, a deceptive passenger will be placed under cognitive pressure. This may change the demeanour of the passenger in a detectable way, such that suspicions can be raised in the screener's mind.

The procedure in accordance with the specific embodiment enables the screener to build rapport with the passenger. Should the screener find nothing untoward in the interaction with the passenger, then the passenger will merely consider that the conversation arising from participating in the process will have been interesting and engaging. A possible outcome of this is enhancement of the customer service role of screening. It also reduces unwarranted biases based on passive observation, it creates opportunities for screeners to create and resolve suspicions of deceit, and provides a timeline in which to observe behavioural change under questioning.

### BRIEF DESCRIPTION OF DRAWINGS

FIG. 1 is a flow diagram of a process of screening an individual in accordance with the specific embodiment of the invention;

FIG. 2 is a schematic diagram of a computer configured to implement the screening process of FIG. 1; and

FIG. 3 is a schematic diagram of a processing unit of the computer illustrated in FIG. 2.

### DETAILED DESCRIPTION

An embodiment described herein provides a process for managing a screening interaction with a passenger, such that more effective information can be gathered about the user's true intentions and identity in order that a judgement of veracity can be made.

An embodiment described herein comprises a method of screening a person, comprising establishing a baseline demeanour of the person, gathering personal information about the person, seeking further information from the person relating to that person's background, asking one or more questions intended to determine if said further information is consistent and reliable and, on the basis of answers to said questions and the demeanour of the person, determining a level of confidence in said person.

The level of confidence can be translated into a screening result. The screening result could be binary (i.e. “pass” or “fail”) or may involve one or more intermediate gradings.

The baseline demeanour may be established by the asking of one or more questions which may be relatively straightforward to answer, such as concerning the personal experience of the person in reaching the point of screening. For example, if the screening is done in an airport environment, the baseline demeanour may be established by asking the person about his journey to the airport, or his destination. The questioner need not know the answer to the question put, and the answer given need not be recorded, as the intent is to check the demeanour of the person at this stage.

Personal information may be gathered contemporaneously via a tactical approach to interviewing, and may be complemented by a process of retrieving information, from a database, of pre-stored information about the person being screened.

The question or questions intended to determine if the further information is consistent and reliable may be derived from verification information known by or accessible to the questioner, and connected to the further information.

The question or questions may be such as to determine if the person, given knowledge of the further information, also knows the verification information. The verification information may comprise factual information which, on the basis of the further information provided by the person, it would be expected that the person would also know. The expectation of the person knowing the verification information, given knowledge of the further information, may be associated with the confidence determined for that person, if that person does not, in fact, know the verification information.

The specific embodiment described herein comprises a process which is dependent on, but not solely comprising, human to human interaction. The key to the process is in providing a framework around which the screener's decision-making about the interviewee's veracity is supported. In addition, the process relies on the ability of a questioner, a screening operative, to determine from changes in body language and other non-verbal communication during the screening process, the demeanour of a screened party. In the present embodiment, the screening operative is a member of staff of an airline, who is trained to make determinations as to the fitness of a potential passenger to travel. Such a person may be dedicated to that task, or may be primarily involved in an associated activity, such as passenger check-in. This screening process may appropriately be carried out at passenger check-in.

The specific embodiment provides a short interview procedure comprising three distinct phases. Although a three phase approach characterises the embodiment, the procedure is presented to the passenger as a homogenous interview so as to avoid arousing suspicion therein.

Each of the three phases of the procedure is intent on gathering information from the prospective passenger. Each phase contributes individually and incrementally to determining whether a passenger is a bona fide traveller without malicious intent or dubious identity. At the same time, the procedure is designed to be efficient, establishing confidence to fly in three minutes.

An information-gathering approach to interview-based screening has the potential to assist screeners to detect deception. This is achieved, in accordance with the present specific embodiment, by defining a number of design layers that maximize deception detection in an airport setting:
1. Design of the types of questions asked and the order of presentation;
2. Design to ensure acquisition of baseline judgement of verbal/dispositional behaviour early in the procedure;
3. Design to ensure an element of uncertainty by asking questions that are less easy for the passenger to anticipate and/or predict (moving away from predetermined scripted questions concerning passenger identity and journey details).
4. Design so that screeners control the face-to-face cognitive encounter, utilising technology to support rather than determine the outcome of screening (avoiding an over-automated or inflexible procedure).

The procedure provides a controlled interviewing procedure with clear exit points. It can be characterised by an incremental questioning approach, with initial questions designed to put the subject at ease and to determine a baseline of the demeanour of the subject, and then further phases of questions designed to establish what version of the truth the subject is intent on presenting, and then methods for testing the version presented by the subject. Through this, by using trained cognitive skills of the screener in a structured way, the screener is able to determine whether the answers given by a passenger are consistent with that passenger being a bona fide traveller, or whether they raise suspicions of deceptive intent.

At the same time, the form of interviewing (i.e. the structure of the interview process) is designed such that, while a genuine traveller will have no difficulty in addressing the questions raised by the screener, a deceptive passenger will be placed under cognitive pressure. This may change the demeanour of the passenger in a detectable way, such that suspicions can be raised in the screener's mind.

The procedure in accordance with the specific embodiment enables the screener to build rapport with the passenger. Should the screener find nothing untoward in the interaction with the passenger, then the passenger will merely consider that the conversation arising from participating in the process will have been interesting and engaging. A possible outcome of this is enhancement of the customer service role of screening. It also reduces unwarranted biases based on passive observation, it creates opportunities for screeners to create and resolve suspicions of deceit, and provides a timeline in which to observe behavioural change under questioning.

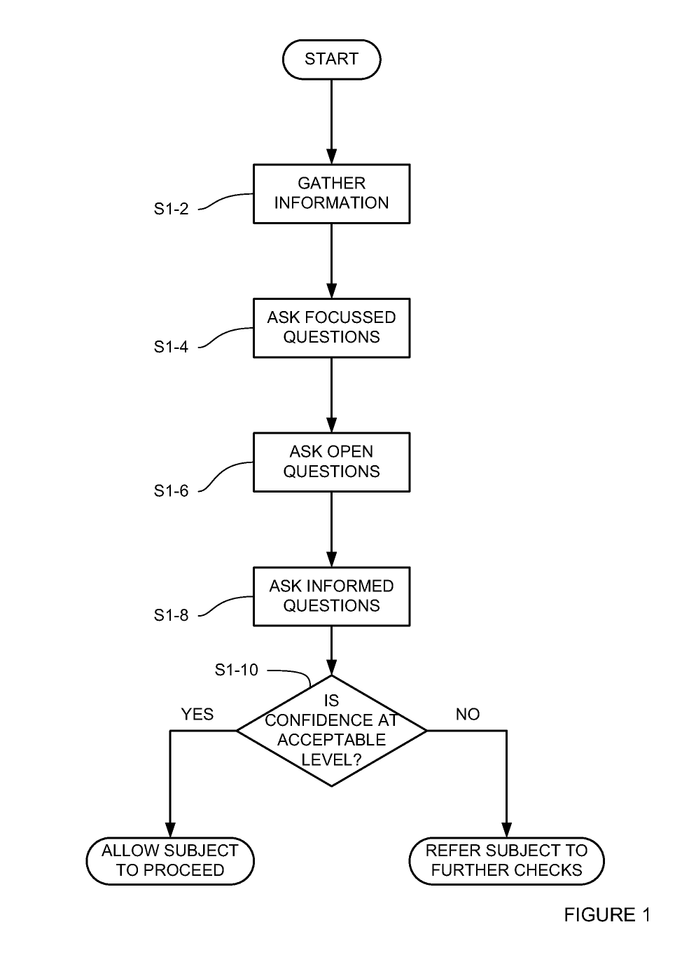

The process, as illustrated in FIG. 1, will now be described in detail. In step S1-2, which is an information gathering step, the security operative takes physical information from the subject, using equipment such as might have been provided to date. This can include taking an electronic/photographic reading from the subject's passport, checking photographic identification against the subject, and accessing any Passenger Name Record (PNR) information relating to the subject and made available to the operative. This establishes the identity claim being made by the subject, and defines a range for use in controlling subsequent questioning. In operational circumstances, it is expected that this step will take roughly 10 seconds to complete.

In step S1-4, which is a first interview phase and should take another 20 seconds, focussed questions are asked about the present day experience of the subject. This can include questions about the subject's journey to the airport, or the subject's destination. Alternatively, and dependent on the range established in step S1-2, questions around the pronunciation of the subject's name, or details of family members, might be appropriate. The purpose of this is to build rapport with the subject and to establish a behaviour baseline, acting as a control for use by the operative in detecting any signs of evasive or stressed behaviour in further interaction with the subject.

In this first interview phase, in accordance with the present embodiment, the screener asks the passenger a focussed question (i.e. one inviting an answer other than a yes/no answer within a finite range of expected answers) selected from a set of unchallenging topics. Examples of this might include:

“How did you travel to the airport today?”, or

“How often have you travelled with XXX Air?”.

Some form of ‘expected’ question pertaining to that person's travel arrangements prior their arrival at the airport is appropriate here. Indeed, passengers are highly expectant of being asked questions of a certain type, such as the standard security questions relating to their luggage which are already almost universally asked. The intention is to start the dialogue without placing passengers, legitimate or deceptive, under pressure, allowing the screener to establish rapport and begin to observe passengers' behaviour and disposition. Should these questions vary unduly from one travel experience to another, a passenger with nothing to hide might be surprised and thus might prove more nervous than their circumstances would merit.

A focussed question is an appropriate baseline question on several counts. Firstly, from the perspective of information-gathering, this type of question encourages the interviewee to respond in a relatively open and unrestricted manner thereby revealing more information than they otherwise might. Secondly, an open question can be viewed as a rapport building tool: by allowing interviewees to speak in an uninterrupted natural manner, about a non-threatening subject/topic, they are put at ease. This is advantageous in that it allows a baseline behavioural (verbal and dispositional) state to be observed. This approach is also beneficial from a customer service/customer experience perspective.

Step S1-6, which is a second phase of the interview, and is envisaged to take around 45 seconds to complete, consists of asking more open questions (characterised by having no limit to the range of expected answers) that are designed to obtain information from the subject, on any factual topic, to enable a version of the truth as proposed by the passenger to be established. Clearly, this will separate passengers into two groups, one being composed of honest and non-deceptive people able to provide candid information about their account of themselves, background circumstances or otherwise which is actually substantially in line with reality, and the other being composed of people who, for whatever reason, have constructed an alternative personal account which is ostensibly internally consistent but which, under further questioning, may be vulnerable to detection as not consistent with reality.

In essence, therefore, the second phase of the interview establishes a “truth version” for use in later parts of the procedure.

The open question of this phase, which can be described as an “account question” is an open-ended invitation. However, in this phase, the specific embodiment of the invention is directed to questions which are temporal in nature (or at least have some temporal element). Thus, questions may focus on past, present or future events. Interviewers should, at this stage, say as little as possible, use pauses and eye contact in a strategic manner, and pay close attention to each interviewee's response.

This question is provided from a large (1 million plus) bank of questions generated in real time and personalised to each passenger's account, thereby reducing a passenger's ability to anticipate the nature of the question. Thus, questions need to come from a range of domains, including questions about:
residence (seeking information about place of upbringing, current permanent address, intended residence, etc);
work (employer, job, skills, qualifications, etc);
people (relatives, renowned people in interviewee's locality, friends, etc); and
journey (purpose, destination, purchase, previous visits, etc)

In contrast with step 1-4, it is important that step 1-6 imposes a demand on a deceptive interviewee to construct a reply that requires them to lie. Thus, it is important here to ask questions requiring interviewees to report information on their identity, links and intentions, three areas under which deceptive passengers are likely to have to lie if they are a threat risk.

Information provided in this phase is then used to guide interviewing in a third phase of the interview, set out in step 1-8, which comprises the posing of “informed questions”. This step again lasts roughly 45 seconds, and comprises the operative asking the subject one or more questions determined on the basis of the “truth version” put forward in the second interview phase. The “correct” answers to such questions will be in a pre-determined range, having regard to information provided in the second phase. That is, salient facts, which may be distilled into keywords, will map to questions to be put in the third phase, and the third phase will be aimed at testing the passenger's ‘truth version’ by seeking answers that, if incorrect (or no adequate answer is provided), demonstrate a possibility that the passenger is intent on deception.

As the third phase takes the form of a closed question, selected with reference to an interviewee's response to questions in the second phase, the screener should have prior knowledge of the answer. A closed question at this point introduces a further layer to the procedure in that it invites a narrow range of responses, often just a few words, or even a yes or no answer if such questions can be framed. Incorrect answers to such questions would be immediately apparent. Further, this type of question allows respondents little time to consider their answer and prevarication becomes obvious.

Moreover, the need to construct a reply that is consistent with a lie given in the second phase places the interviewee under cognitive load, allowing an opportunity for the screener to observe behavioural change.

The operative then, in step S1-10, makes a determination, on the basis of the answers and the behaviour of the passenger as to whether the passenger has provided the operative with sufficient confidence as to allow the passenger to travel. If so, then the passenger is allowed to proceed to check-in, and to travel. If not, and as this is a screening process, the passenger may be subjected to further investigation, which might lead to the passenger being allowed to travel or might discover further information on the basis of which the passenger will be denied access to an aircraft.

In order to move from generic to informed questioning, an interviewer needs access to passenger-specific domain knowledge. Clearly, the screener cannot know the answers in advance to all the questions that a passenger might be asked. Moreover, it is beyond the cognitive limitations of most adults to be able to construct suitable novel questions in real time. Thus, technological assistance is crucial to the success of the described approach.

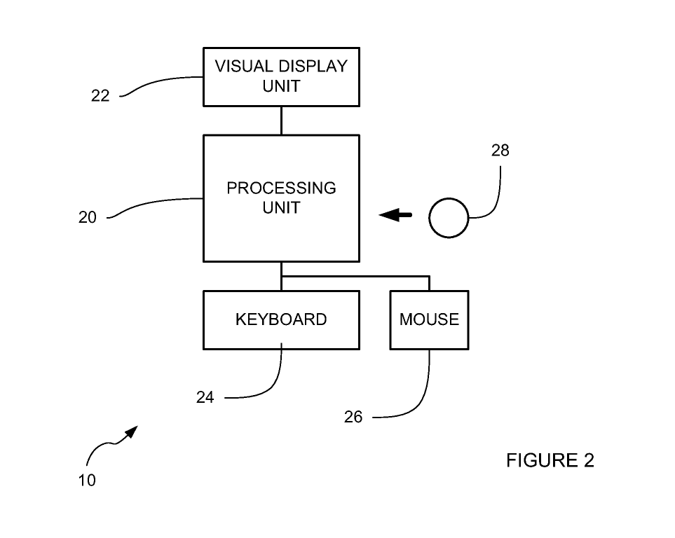

FIG. 2 illustrates a computer 10 configured to aid the interviewer in conducting the process previously described. The computer 10 comprises a processing unit 20, to which is connected a visual display unit, VDU, 22, a keyboard 24 and a mouse 26. Also illustrated is an optical disk 28, storing computer program instructions suitable for the configuration of the computer.

The reader will appreciate that a computer program product could be delivered to the computer in a variety of different forms. For instance, as well as being on a storage medium, such as the illustrated optical disk 28, a computer program product can be delivered by means of a signal, such as established on a connection to the Internet. Further, a computer program product can comprise a complete set of computer program instructions which, when executed, cause the computer to become configured as desired, or can comprise a set of instructions which cooperate with other computer program elements already stored in the computer stop thus, an application could be designed to cooperate with an operating system, or a plug-in could be designed to cooperate with an existing application.

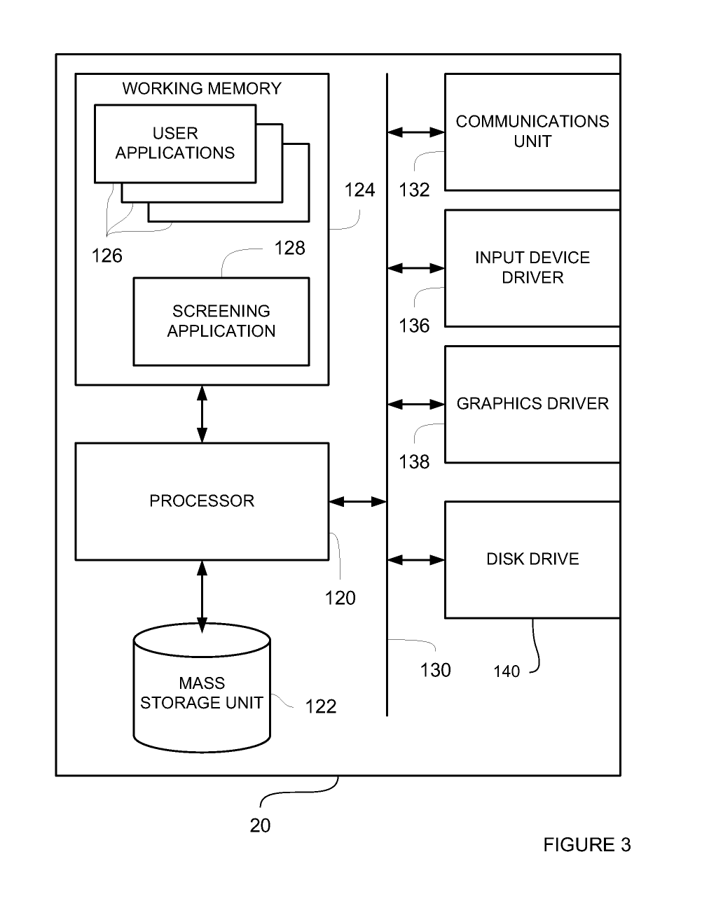

As illustrated in FIG. 3, the processing unit 20 comprises a processor 120, to which is connected a mass storage unit 122. The mass storage unit may be in the form of a hard disk drive, or solid-state memory, or any other implementation suitable to the application. Also provided is a working memory 124, in which program and data elements can be stored for quick and direct access by the processor 120. As illustrated, user applications 126 and a screening application 128 are stored in working memory 124. The reader will appreciate that, in many circumstances, a computer may be configured to store only portions of program elements in working memory, for ease and convenience. It might be that a virtual memory is defined in the mass storage unit 122, in certain circumstances.

A bus 130 is provided, through which the processor 120 has access to a communications unit 132, which could be used by the processor 120 to gain access to resources beyond the computer 10. Thus, the communications unit 132 could be used to establish connection to other computers, such as by way of a local area network, LAN, or to a wider network such as the Internet.

An input device driver 136 provides interface for the keyboard 24 and the mouse 26. A graphics driver 138 provides interface to the VDU 22. A disk drive 140 is illustrated, for reception of an optical disk 28.

The computer 10 provides two aspects of technical support.

The first aspect comprises a screen-based workflow dialogue that steps through the phases of the process illustrated in FIG. 1, prompting the screener to ask questions and to acknowledge or record answers.

The second aspect comprises the supply of appropriate questions and answers to the interviewer.

The screening application 128 causes the computer to firstly collect electronic data (as much as is possible) from the interviewee's identity documentation (eg passport), electronic travel record, and (optionally) frequent flyer record. This provides a first set of passenger-specific data from which to generate questions. To do this, the screening application 128 causes the computer to offer a graphical user interface, GUI, to the screener, to prompt collection of this information. In some circumstances, it may be possible to collect this information electronically. For instance, many passports now contain storage devices bearing biometric information, and a suitable reader could be provided with the computer 10 to allow the computer to gather this information.

Stage 1 of the illustrated process has the purpose of information gathering, and the establishment of a baseline. The questions asked of the interviewee are “expected” questions to do with the travel process.

Based on the initial electronic data, the screening application 128 causes the computer to display, on the VDU 22, a GUI which prompts the interviewer with focussed questions to ask the interviewee (and shows the correct answers to the interviewer), such as:
What is you final destination'? ZZZZZZ
How do you spell your family name? SMITH
Could you confirm your date of birth? YYYY-MM-DD
How often do you travel with XXX Airlines? Never before
How long will you be staying in YYY? 4 nights

It is unlikely that Stage 1 generates any problems for the interviewee, but any factual inconsistencies could be identified as an immediate cause for concern.

The GUI then displayed on screen will give the interviewer at least the following options:
To ask a further stage 1 question
To proceed to stage 2
To mark the interviewee immediately as a “selectee” for more detailed screening

Stage 2 (step 1-6) is further information gathering, but here the interviewer is required to pose more open questions in order to solicit longer answers from the interviewee. The screening application causes the computer to generate and display a GUI which presents these questions either as generic open questions, or it may base them on the existing data. For example:
How did you travel here today?
What is the purpose of your travel to ZZZZZZ!
What sort of work do you do? Who do you work for?
Have you lived and worked in other countries? Where?

In most cases the answers to these questions will not be known before the procedure commences, and so there will be no answer information stored by the computer alongside the questions. In some cases the interviewer may be required to type the interviewee's answer into a text box in the GUI, or to select from a menu of options, thus collecting more passenger-specific information.

The GUI will then advance to a further screen which gives the interviewer at least the following options:

To ask a further stage 2 question

To proceed to stage 3

To mark the interviewee as a “selectee” for more detailed screening

The key role of Stage 3 (step 1-8) is to impose a demand on a deceptive interviewee to construct a reply that requires them to lie. Thus, it is important here to ask specific questions requiring interviewees to report information on topics such as their identity, links and intentions, areas under which deceptive passengers are likely to have to lie if they are a threat risk.

These are closed questions, with a “right” answer that the interviewee is expected to know without having to think, and are based on information provided in Stage 2 (or earlier). The screening application 128 provides a question and the expected answer(s). Note that the correctness or otherwise of the answer is not the sole determinant of selecting a “selectee”.

For example:
What is the big department store in downtown [city]? AAAAAAA
MMMM MMMMMM still the mayor of [city]? No, it's now BBB BBBBB
What's the name of the chocolate factory in [city]? CCCCCC
What is you current permanent address in [country/city]? DDDDDDDD
When and where did you buy your ticket? EEEEEE and YYYY-MM-DD
Where did you live when you worked in [country]? FFFFFF
What's the name of that really tall building in [city]? GGGG Tower

The screen gives the interviewer the (at least) options:

Correct and timely answer

No answer

Incorrect answer

The question made the Interviewee appear nervous/unsettled

Then the screen gives the interviewer the (at least) options:

To ask a further stage 3 question

To mark the interviewee as acceptable to travel

To mark the interviewee as a “selectee” for more detailed screening

Optionally the screen may show a clock showing how long the interview has been in progress.

It will be appreciated that in Stage 1, the answers to the questions are based on known data provided electronically about the traveller.

In Stage 2, the answers are not known, but are collected.

In Stage 3, there are many more possible questions and answers. Whereas steps 1 and 2 might be considered capable of implementation without computer support, this is not the case for stage 3.

In one approach to implementation of this embodiment, a large database of questions and answers is stored in the mass storage unit 122. Here the screening application 128 uses a known data item from the interviewee's profile in order to select an appropriate question. Typically there will be many questions per keyword (for example associated with a city) and the screening application 128 makes a random selection within this set.

Another approach uses a data mining capability with semantic technology. Here structured or semi-structured knowledge stored on the internet or an intranet is coded semantically using languages such as Web Ontology Language (OWL) and/or Resource Description Framework (RDF). These languages code content in terms of its meaning, inter-relations and uses. Increasingly resources coded semantically are becoming available, including DBMedia (an RDF database allowing advanced queries using Wikipedia data), and PiggyBank, which accesses information semantically and displays it via GoogleMaps.

Another approach, which could be used in conjunction with the above, would be to use an offline semantic tool very rapidly to generate a set of questions and answers from a list of given keywords. It is then very efficient for a human to check the questions and answers for suitability (rather than constructing them all by hand), and for the software to add them to the database.

Whilst certain embodiments have been described, these embodiments have been presented by way of example only, and are not intended to limit the scope of the inventions. Indeed, the novel devices, methods and products described herein may be embodied in a variety of other forms; furthermore, various omissions, substitutions and changes in the form of the devices, methods and products described herein may be made without departing from the spirit of the inventions. The accompanying claims and their equivalents are intended to cover such forms or modifications as would fall within the scope and spirit of the inventions.

What is claimed is:

1. A method of screening a person, comprising:
establishing a baseline demeanour of the person;
gathering personal information about the person;
seeking further information from the person relating to that person's background;
asking one or more questions intended to determine if said further information is consistent and reliable and;
on the basis of answers to said questions and the demeanour of the person, determining a level of confidence in said person.

2. A method in accordance with claim 1 wherein the level of confidence is translated into a screening result.

3. A method in accordance with claim 2 wherein the screening result is selected from a pre-determined set of possible results.

4. A method in accordance with claim 3 wherein the set of possible results comprises two possible results.

5. A method in accordance with claim 1 wherein the question or questions intended to determine if the further information is consistent and reliable may be derived from verification information known by or accessible to the questioner, and connected to the further information.

6. A method in accordance with claim 5 wherein said question or questions are such as to determine if the person, given knowledge of the further information, also knows the verification information.

7. A method in accordance with claim 5 wherein the verification information comprises factual information which, on the basis of the further information provided by the person, it would be expected that the person would also know.

8. A method in accordance with claim 7 wherein the expectation of the person knowing the verification information, given knowledge of the further information, is associated with the confidence determined for that person, if that person does not, in fact, know the verification information.

9. A computer apparatus for use in supporting a screening process, the computer apparatus being operable to offer to a user a user interface, the computer apparatus comprising:
target information receiving means operable to receive target information about the target;
question generation means operable to generate one or more questions based on the target information
response receiving means operable to receive a response to a question generated by the question generation means and
response assessment means operable to assess the response and to determine a screening result for the target.

10. Apparatus in accordance with claim 9 wherein said question generation means is operable to extract, from said target information, keywords on the basis of which said question or questions are generated.

11. Apparatus in accordance with claim 9 and further comprising a database of questions, the question generation means being operable to retrieve one or more questions on the basis of said target information.

12. Apparatus in accordance with claim 9 and further comprising information retrieval means, operable to retrieve information from a remote location, on the basis of said target information, to cause construction of a question on the basis of said target information.

13. Apparatus in accordance with claim 9 wherein, alongside a generated question, a preferred response is provided, such that said response assessment means can assess the target response against the preferred response and determine said screening result accordingly.

14. A computer program product comprising computer executable instructions which, when executed by a suitable computer, cause the computer to become configured as computer apparatus in accordance with claim 9.

15. A computer readable medium storing instructions, which when executed by a computer, cause the computer to perform a process of screening a person comprising:
establishing a baseline demeanour of the person;
gathering personal information about the person;
seeking further information from the person relating to that person's background;
asking one or more questions intended to determine if said further information is consistent and reliable and;
on the basis of answers to said questions and the demeanour of the person, determining a level of confidence in said person.

16. A computer readable medium in accordance with claim 15 wherein the level of confidence is translated into a screening result.

17. A computer readable medium in accordance with claim 16 wherein the screening result is selected from a pre-determined set of possible results.

18. A computer readable medium in accordance with claim 17 wherein the set of possible results comprises two possible results.

19. A computer readable medium in accordance with claim 15 wherein the question or questions intended to determine if the further information is consistent and reliable may be derived from verification information known by or accessible to the questioner, and connected to the further information.

20. A computer readable medium in accordance with claim 19 wherein said question or questions are such as to determine if the person, given knowledge of the further information, also knows the verification information.

21. A method in accordance with claim 19 wherein the verification information comprises factual information which, on the basis of the further information provided by the person, it would be expected that the person would also know.

22. A method in accordance with claim 21 wherein the expectation of the person knowing the verification information, given knowledge of the further information, is associated with the confidence determined for that person, if that person does not, in fact, know the verification information.
